(19) United States
(12) Patent Application Publication
(10) Pub. No.: US 2013/0276015 A1
(43) Pub. Date: Oct. 17, 2013

(54) VIRTUAL SET-TOP BOXES

(71) Applicants: Keith Alan Rothschild, Dunwoody, GA (US); Rachel Snow, Marietta, GA (US); James Kelso, Marietta, GA (US)

(72) Inventors: Keith Alan Rothschild, Dunwoody, GA (US); Rachel Snow, Marietta, GA (US); James Kelso, Marietta, GA (US)

(73) Assignee: COX COMMUNICATIONS, INC., Atlanta, GA (US)

(21) Appl. No.: 13/448,864

(22) Filed: Apr. 17, 2012

(51) Int. Cl. H04N 21/45

(52) U.S. Cl. 725/25; 725/110

(57) ABSTRACT

Systems and methods for providing virtual set-top boxes are described. A virtual set-top box associated with at least one of a customer of a service provider or a customer account with the service provider may be established by a service provider system. A communications session with a customer device may be established by the service provider system via a wide area network. Based upon the established communications session, the virtual set-top box may be initiated by the service provider system. One or more parameters for communicating content from the virtual set-top box to the customer device may be identified, and the content may be communicated by the service provider system to the customer device based at least in part upon the identified one or more parameters.

### TECHNICAL FIELD

Aspects of the disclosure relate generally to set-top box functionality, and more particularly, to the establishment of network-based virtual set-top box services.

### BACKGROUND

Broadband service providers, such as cable service providers and satellite service providers, typically communicate broadband signals and/or other signals to customers in order to provide a wide variety of services, such as television service, telephone service, Internet service, etc. In conventional systems, a signal is communicated from a service provider to a set-top box (“STB”) situated within a customer's household. The signal is then processed by the STB in order to format data for presentation to the customer. Additionally, many conventional systems utilize digital video recorders (“DVRs”) to facilitate the recording of broadband content at the customer's direction. Conventional DVRs are typically situated within the customer's household.

However, the location or situation of STBs and DVRs inside of households may make it difficult for the service provider to respond to and/or correct technical service issues. With devices inside of a household, the service provider will often need to have a technician enter the household in order to address any equipment issues. Additionally, a customer of the service provider may remove a device belonging to the service provider when the customer moves. Moreover, a conventional STB typically limits content access to the household.

With the increased use of additional types of devices that may be configured to receive content, such as tablets, mobile devices, and/or personal computers, a service provider has opportunities to provide content to a wide variety of different devices. However, for various reasons, such as content distribution requirements, the service provider may desire to limit content access for these additional customer devices. Conventional slingboxes utilize placeshifting to avoid copyright infringement. However, placeshifting relies on the redirection of content, thereby requiring a slingbox to typically be connected to a set-top box situated within a customer's household. Accordingly, improved systems, methods, and apparatus for distributing and delivering content are desirable.

### BRIEF DESCRIPTION

Some or all of the above needs and/or problems may be addressed by certain embodiments of the disclosure. Embodiments of the disclosure may include systems and methods for establishing virtual STBs and utilizing the virtual STBs to distribute content to customer devices. In one embodiment, a method for establishing a virtual STB and utilizing the virtual STB to distribute content may be provided. A virtual set-top box associated with at least one of a customer of a service provider or a customer account with the service provider may be established by a service provider system that includes one or more computers. A communications session may be established by the service provider system with a customer device via a wide area network. Based upon the established communications session, the virtual set-top box may be initiated by the service provider system. One or more parameters for communicating content from the virtual set-top box to the customer device may be identified by the service provider system. Based at least in part upon the identified one or more parameters, the content may be communicated by the service provider system to the customer device.

In accordance with another embodiment of the disclosure, a system for establishing a virtual STB and utilizing the virtual STB to distribute content may be provided. The system may include at least one memory and at least one processor. The at least one memory may be configured to store computer-executable instructions. The at least one processor may be configured to access the at least one memory and execute the computer-executable instructions to: establish a virtual set-top box associated with at least one of a customer of a service provider or a customer account with the service provider; establish, via a wide area network, a communications session with a customer device; initiate, based upon the established communications session, the virtual set-top box; identify one or more parameters for communicating content from the virtual set-top box to the customer device; and communicate, to the customer device based at least in part upon the identified one or more parameters, the content.

Additional systems, methods, apparatus, features, and aspects may be realized through the techniques of various embodiments of the disclosure. Other embodiments and aspects of the disclosure are described in detail herein with reference to the description and to the drawings and are considered a part of the claimed invention.

### BRIEF DESCRIPTION OF THE DRAWINGS

Reference will now be made to the accompanying drawings, which are not necessarily drawn to scale, and wherein:

FIG. 1 illustrates a block diagram of an example system that may be utilized to facilitate the establishment of virtual STBs and the delivery of content via the virtual STBs.

FIG. 2 is a block diagram of an example architecture of a virtual STB service provider system.

FIG. 3 is a flow diagram of an example method for utilizing a virtual STB to deliver content to a customer device.

FIG. 4 is a flow diagram of an example method for determining a resolution for communicating content to a customer device via a virtual STB.

FIG. 5 is a flow diagram of an example method for generating one or more interfaces associated with a virtual STB.

### DETAILED DESCRIPTION

Embodiments of the disclosure now will be described more fully hereinafter with reference to the accompanying drawings, in which embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the disclosure may include systems and methods for providing virtual STBs. In certain embodiments, a virtual STB may be established by a service provider in association with either a customer or a customer account. For example, a customer may register for and, in certain embodiments, be charged for a virtual STB. In certain embodiments, the customer may “rent” resources, such as cloud resources or network-based resources, that are utilized to provide STB functionality to one or more customer devices. Once established, a virtual STB may be accessed by the customer utilizing any number of suitable customer devices, such as a personal computer, a tablet computer, a mobile device, a network-enabled television, etc. In this regard, the virtual STB may provide content to the customer device. Additionally, the virtual STB may facilitate the protection and security of delivered content.

In certain embodiments, a virtual STB may provide functionality similar to that provided by a conventional STB, such as a conventional STB connected to a television. Examples of suitable services that may be provided by a virtual STB include, but are not limited to, the delivery of television content, electronic program guide (“EPG”) functionality, enhanced television binary interchange format (“EBIF”) functionality, Internet television functionality, video on-demand functionality, pay-per-view functionality, network recording functionality, voice over Internet protocol (“VoIP”) functionality, caller identification functionality, and/or parental control functionality. In certain embodiments, a virtual STB may provide content navigation and/or interactive services that produce any number of graphical outputs that are overlaid on a video output communicated to a customer device.

In operation, following the establishment of a virtual STB, a customer may utilize a customer device to access the virtual STB. For example, the customer may log in through a virtual STB portal which authenticates the customer and verifies user subscription levels. The virtual STB may then generate any number of suitable interfaces that facilitate the delivery of content to the customer device. As desired, a generated interface may facilitate the receipt of customer input. For example, a generated interface may facilitate the receipt of customer inputs similar to inputs received by a conventional STB, such as tuning inputs, content selection inputs, purchase inputs, recording inputs, and/or requests to view content recorded at a network level.

In certain embodiments, network resources and/or capabilities of a customer device (e.g., display capabilities, input capabilities, available content protection techniques, etc.) may be taken into consideration during the generation of interfaces and/or during the delivery of content. Additionally, in certain embodiments, a customer may be permitted to set one or more content delivery parameters (e.g., a desired bandwidth, a desired resolution, a desired frame-rate, etc.) associated with content delivery. In other embodiments, the quality of delivered content (e.g., resolution, etc.) may be dynamically adapted based upon available network resources, device capabilities, and/or customer parameters (e.g., ranges of acceptable values, etc.). Additionally, delivered content may be protected via a wide variety of suitable protection techniques, such as link-level encryption, digital rights management (“DRM”), and/or conditional access system (“CAS”) protection.

System Overview

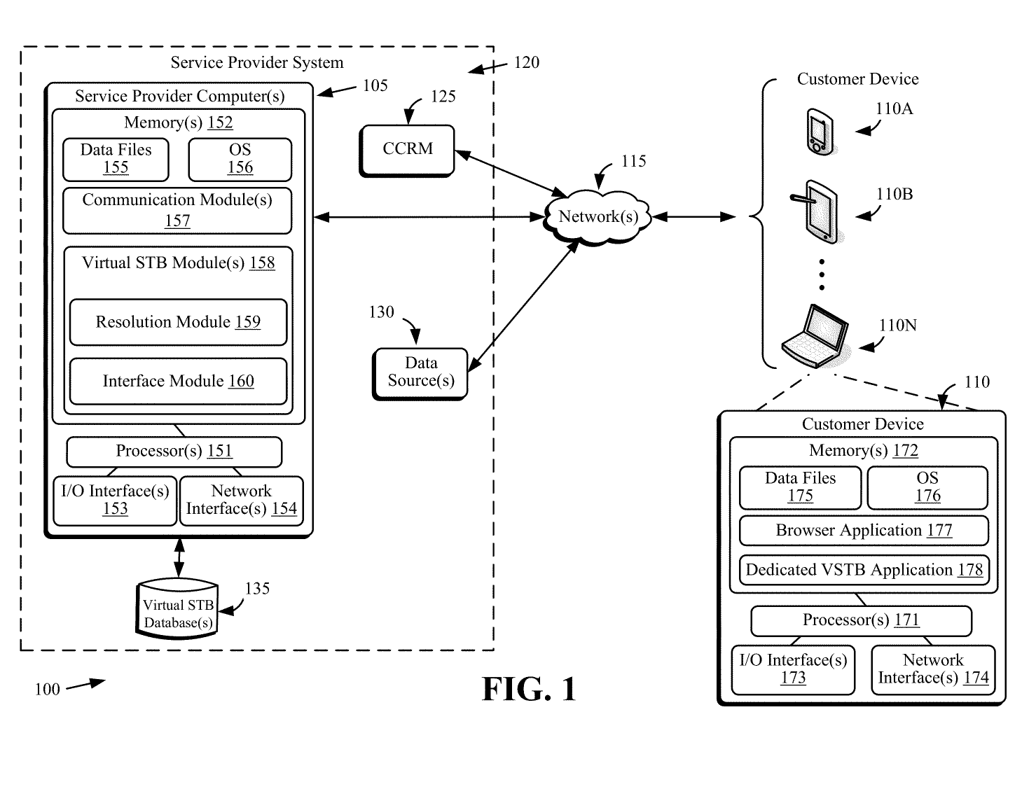

An example system 100 for facilitating the establishment of virtual STBs and the delivery of content via the virtual STBs will now be described illustratively with respect to FIG. 1. The system 100 may include, for example, one or more service provider computers 105 and/or one or more customer devices 110A-N. Any number of suitable networks 115 may facilitate communications between the service provider computers 105 and the customer devices 110A-N. Additionally, in certain embodiments, the service provider computers 105 may be associated with a suitable service provider system 120, such as a service provider system associated with a cable service provider, a satellite service provider, or other provider of broadband content. As desired, the service provider system 120 may include or otherwise be associated with any number of other components in communication with the service provider computers 105 via the networks 115, such as a cloud computing resource manager (“CCRM”) 125 and/or any number of suitable data sources 130. Additionally, in certain embodiments, the service provider computers 105 (or other components of the service provider system 120) may include and/or be in communication with any number of suitable databases 135.

As desired, the various components of the service provider system 120 may be situated at any number of suitable network locations. For example, the service provider computers 105 may be cloud computing servers situated at various locations, and the CCRM 125 may manage the assignment of resources associated with the service provider computers 105. In other embodiments, the service provider computers 105 may be situated at one or more relatively centralized locations that are accessible by various customer devices 110A-N. Additionally, as mentioned above, any number of suitable networks 115 may facilitate communication between the various components of the system 100. As desired, these networks 115 may include any number of public and/or private networks. Example networks include, but are not limited to, cable networks, satellite networks, telecommunication networks, data networks, wide area networks, the Internet, public switched telephone networks, satellite networks, and/or any combination thereof and may be wired and/or wireless. In certain embodiments, the networks 115 may include one or more private networks and/or backbone networks associated with a service provider (e.g., a cable service provider, etc.) that operates and/or directs the operations of the various components of the service provider system 120. Additionally, as desired, any number of suitable devices, such as gateways and/or routers, may be provided to facilitate connectivity between or among networks.

Any number of service provider computers 105 may be provided as desired in various embodiments. A service provider computer 105 may be a suitable processor-driven device configured to establish a virtual STB, establish communication with a customer device 110, and implement an instance of the virtual STB on behalf of the customer device 110. Examples of suitable processor-driven devices that may be utilized as a service provider computer 105 include, but are not limited to, a server computer, a personal computer, a digital assistant, a personal digital assistant, a digital tablet, an Internet appliance, an application-specific circuit, a microcontroller, a minicomputer, any other processor-based device, and/or any combination of processor-driven devices. The execution of suitable computer-implemented instructions or computer-executable instructions by the service provider computer 105 may form a special purpose computer or other particular machine that is operable to facilitate establishment and/or implementation of a virtual STB.

In addition to one or more processors 151, the service provider computer 105 may include one or more memory devices 152, one or more input/output (“I/O”) interfaces 153, and/or one or more network interfaces 154. The processors 151 may be configured to execute any number of software applications and/or computer-readable or computer-executable instructions. The memory devices 152 (also referred to as memory 152) may include any number of suitable memory devices, such as caches, read-only memory devices, random access memory devices, flash memory devices, magnetic storage devices, etc. The memory 152 may store data, executable instructions, and/or various program modules utilized by the processors 151. Examples of data that may be stored by the memory devices 152 include data files 155 and/or any number of suitable data repositories (e.g., databases, etc.), such as one or more virtual STB databases 135. Additionally, the memory devices 152 may be configured to store any number of suitable program modules and/or applications that may be executed by the processors 151, such as an operating system (“OS”) 156, one or more communication modules 157, and/or one or more virtual STB modules 158. As desired, the virtual STB modules 158 may include any number of suitable applications, sub-modules, and/or components, such as a resolution module 159 and/or an interface module 160.

The data files 155 may include any suitable data that facilitates the operation of the service provider computer 105. Examples of suitable information stored in the data files 155 include, but are not limited to, information associated with the operation of various service provider computers 105, information associated with available cloud and/or service provider system resources, information associated with customers, customer account information, customer profile information, information associated with the establishment of virtual STBs, information associated with established virtual STBs, information associated with established communications sessions with customer devices 110A-N, and/or information associated with instituted virtual STBs. In certain embodiments, one or more virtual STB databases 135 may be provided, and the databases 135 may include a wide variety of information associated with virtual STBs. Examples of suitable information that may be stored in the databases 135 include, but are not limited to, information associated with established virtual STBs (e.g., customer information and/or customer account information associated with established and/or purchased virtual STBs), information associated with customer identification and/or access information, customer account information, customer device information, information associated with the communications and/or presentation abilities of customer devices, and/or any number of customer preferences associated with the delivery of content and/or the processing of customer input. In certain embodiments, the databases 135 may be stored on the service provider computers 105. In other embodiments, the databases 135 may be directly or indirectly accessible via any number of suitable network connections.

The OS 156 may be a suitable software module that controls the general operation of the service provider computer 105. The OS 156 may also facilitate the execution of other software modules by the processors 151, for example, the communication module(s) 157 and/or the virtual STB modules 158. The one or more communication modules 157 may include any number of suitable software modules and/or applications that facilitate the establishment of communications sessions with any number of other components of the system 100. For example, the communication modules 157 may facilitate the establishment of network communications sessions with any number of suitable customer devices 110A-N. In certain embodiments, a communication module 157 may function as a suitable portal (e.g., an Internet or Web portal, etc.) that is accessible by a customer device 110. As desired, a communication module 157 may authenticate a customer or customer device 110 either during the establishment of a communications session or following the establishment of a communication sessions. In this regard, a determination may be made as to whether a customer or customer device 110 is permitted and/or authorized to access and/or utilize a virtual STB. A wide variety of suitable authentication techniques may be utilized as desired in various embodiments including, but not limited to, user name and password authentication, digital certificates, and/or other forms of authentication. In certain embodiments, received access and/or authentication information may be compared to stored information associated with established virtual STBs, and a customer or customer device 110 may be authenticated based upon a determined correspondence between the received information and the stored information.

The virtual STB modules 158 may include any number of suitable modules and/or applications that facilitate the initiation and/or management of any number of virtual STBs. Although the communication modules 157 are described above as authenticating customers and/or customer devices, in certain embodiments, a virtual STB module 158 may facilitate the authentication of a customer or customer device. A virtual STB module 158 may initiate a virtual STB that provides functionality similar to that provided by a conventional STB. Examples of suitable services that may be provided by a virtual STB include, but are not limited to, the delivery of television content, electronic program guide (“EPG”) functionality, enhanced television binary interchange format (“EBIF”) functionality, Internet television functionality, video on-demand functionality, pay-per-view functionality, network recording functionality, voice over Internet protocol (“VoIP”) functionality, caller identification functionality, and/or parental control functionality.

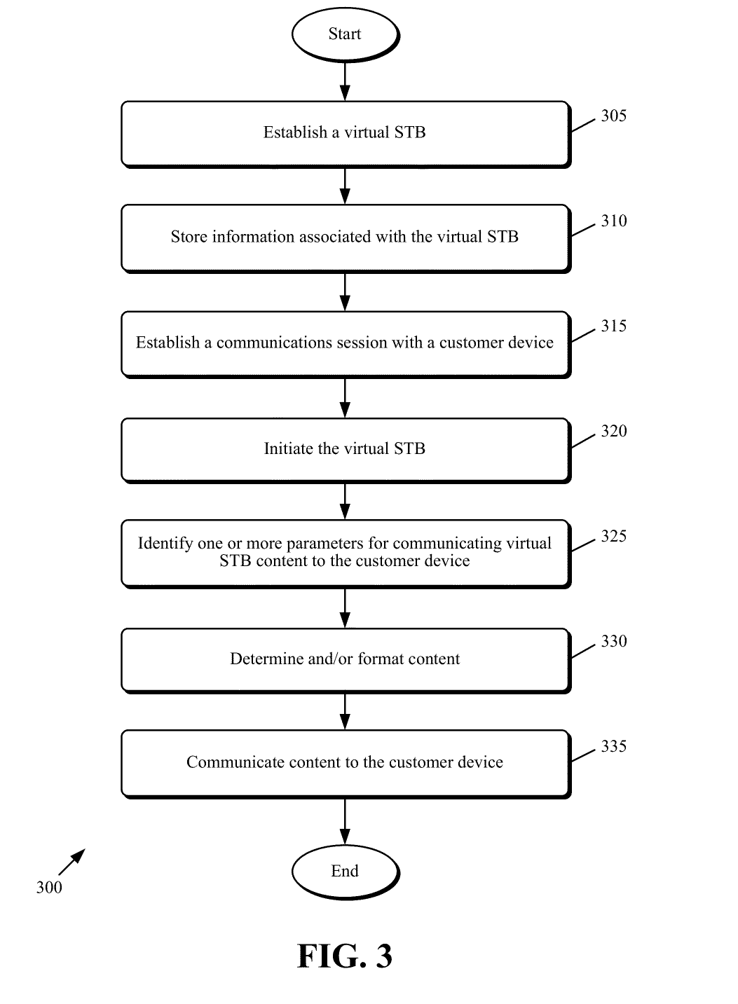

In operation, the virtual STB module 158 may initiate a virtual STB on behalf of a requesting customer or customer device 110. Additionally, the virtual STB module 158 may identify one or more parameters for communicating virtual STB content and/or data to the customer device 110. A wide variety of suitable parameters may be identified as desired in various embodiments including, but not limited to, parameters associated with the input/output capabilities of the customer device 110, encryption and/or data protection parameters, resolution parameters, frame rate parameters, network resource parameters (e.g., available bandwidth, etc.). In certain embodiments, one or more of the parameters may be received from the customer device 110 and/or accessed from any number of suitable user profiles associated with the virtual STB. Based at least in part upon the identified one or more parameters, the virtual STB module 158 may determine and/or format content for delivery to the customer device 110. Additionally, the virtual STB module 158 may communicate or direct communication of the content to the customer device 110. One example of the operations that may be performed by one or more virtual STB modules to initiate a virtual STB and provide content to a customer device 110 is described in greater detail below with reference to FIG. 3.

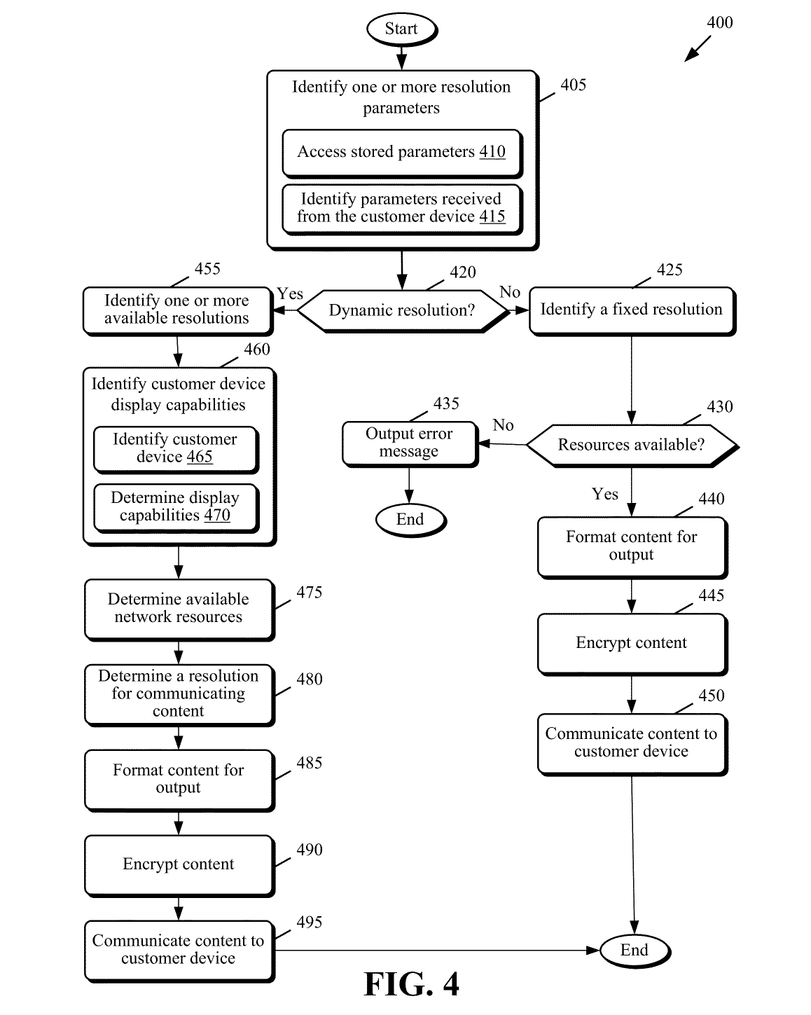

A resolution module 159 may be a suitable module, sub-module, or application that facilitates the formatting of content delivered to a customer device 110 via a virtual STB. In operation, the resolution module 159 may identify one or more resolution and/or display parameters associated with the delivery of content, for example, by accessing stored customer and/or default parameters and/or by receiving parameters from a customer device 110. Based at least in part upon the resolution and/or display parameters, the resolution module 159 may determine a resolution for delivering content to a customer device. In certain embodiments, the determined resolution may be a fixed resolution and, in the event that sufficient network resources and/or device capabilities are available, the resolution module 159 may direct the communication of content to the customer device 110. In other embodiments, the determined resolution may be a dynamic resolution. In this regard, quality of delivered content (e.g., resolution, etc.) may be dynamically adapted based upon available network resources, device capabilities, and/or customer parameters (e.g., ranges of acceptable values, etc.). Additionally, delivered content may be protected by a resolution module 159 (or the virtual STB module 158) via a wide variety of suitable protection techniques, such as link-level encryption, digital rights management (“DRM”), and/or conditional access system (“CAS”) protection. One example of the operations that may be performed by the resolution module 159 is described in greater detail below with reference to FIG. 4.

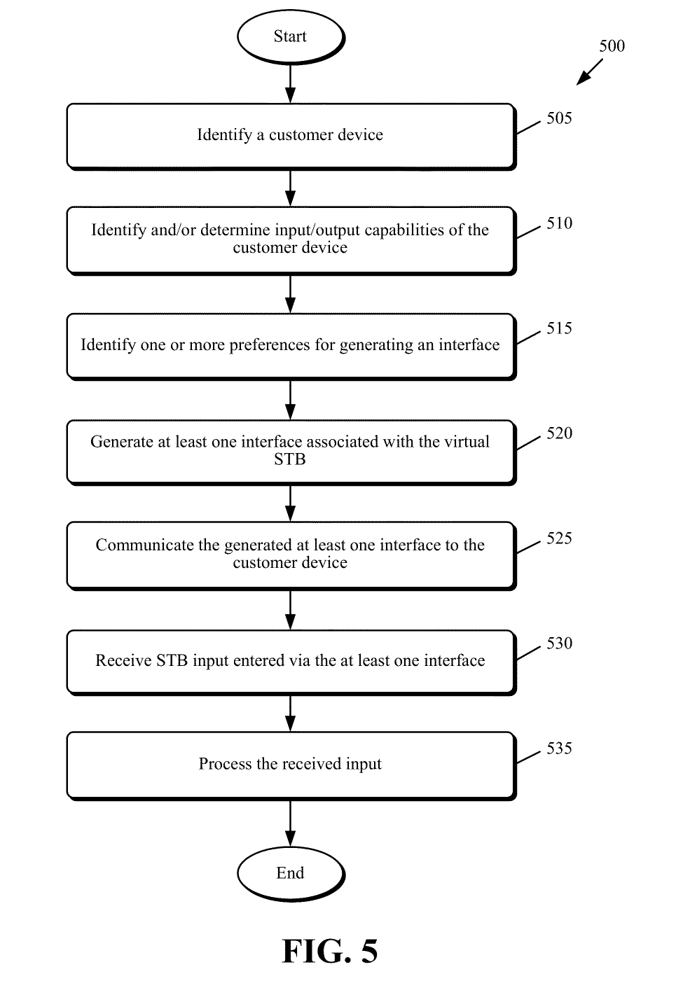

An interface module 160 may be a suitable module, sub-module, or application that facilitates the generation of any number of suitable interfaces that facilitate the delivery of content to a customer device 110. As desired, a generated interface may facilitate the display and/or presentation of content via the customer device 110, as well as the receipt of customer input via the customer device 110. For example, a generated interface may facilitate the receipt of customer inputs similar to inputs received by a conventional STB, such as tuning inputs, content selection inputs, purchase inputs, recording inputs, and/or requests to view content recorded at a network level. In certain embodiments, the interface module 160 may tailor or customize an interface based upon the input/output capabilities of the customer device 110 and/or any number of interface generation parameters (e.g., customer preferences, default parameters, etc.). One example of the operations that may be performed by the interface module 160 is described in greater detail below with reference to FIG. 5.

With continued reference to the service provider computer 105, the one or more I/O interfaces 153 may facilitate communication between the service provider computer 105 and one or more input/output devices, for example, one or more user interface devices, such as a display, keypad, mouse, pointing device, control panel, touch screen display, remote control, microphone, speaker, etc., that facilitate user interaction with the service provider computer 105. In this regard, user commands may be received by the service provider computer 105. The one or more network interfaces 154 may facilitate connection of the service provider computer 105 to one or more suitable networks 115. In this regard, the service provider computer 105 may communicate with one or more other components of the system 100.

With continued reference to the service provider system 120, any number of other components may be in communication with the service provider computers 105 via the networks 115. For example, in embodiments in which the service provider computers 105 are cloud computers, a CCRM 125 may be included in the service provider system 120. The CCRM 125 may facilitate the management of resources among the various cloud computers. For example, the CCRM 125 may direct the initiation of virtual STBs on various service provider computers 105. Additionally, the CCRM 125 may allocate memory and/or processing resources of the various service provider computers 105 to any number of executing processes, including executing virtual STBs. In certain embodiments, a CCRM 125 may be a suitable computing device that includes components similar to those described above for the service provider computer 105. In other embodiments, a CCRM 125 may include one or more modules and/or applications that are executed by another component of the system 100, such as one of the service provider computers 105.

As desired, the service provider system 120 may include any number of suitable data sources 130. A data source 130 may be configured to provide a wide variety of different types of information to a service provider computer 105 for use in association with one or more virtual STBs. Examples of suitable data that may be provided by a data source 130 include, but are not limited to, information associated with established virtual STBs, customer information, customer profile information, customer account information, data protection information, conditional access information, electronic program guide information, stored or recorded content, and/or content received from one or more content providers. In certain embodiments, a data source 130 may be a suitable computing device that includes components similar to those described above for the service provider computer 105. Additionally, as desired in various embodiments, one or more data sources may be remote data sources that are not incorporated into the service provider system 120.

With continued reference to FIG. 1, any number of customer devices, such as devices 110A-N, may be provided. A customer device (individually referred to as customer device 110) may be a suitable device configured to receive and process content associated with a virtual STB. A wide variety of suitable customer devices, such as a mobile device 110A (e.g., a mobile telephone, a personal digital assistant, etc.), a tablet computer 110B, or a personal computer 110N, may be provided. In certain embodiments, the customer devices 110A-N may provide outlets for customers of the service provider to receive and/or view content.

An example customer device 110 will now be described. The customer device 110 may be a suitable processor-driven device that facilitates the receipt, processing, presentation, and/or output of content associated with a virtual STB, as well as the receipt of user input associated with a virtual STB. The customer device 110 may include any number of computing devices, such as a personal computer, a digital assistant, a personal digital assistant, a digital tablet, an Internet appliance, an application-specific circuit, a microcontroller, a minicomputer, or any other processor-based device. The execution of suitable computer-implemented instructions or computer-executable instructions by the customer device 110 may form a special purpose computer or other particular machine that is operable to facilitate the establishment of a communications session with a service provider computer 105, the receipt and processing of virtual STB information, and/or the receipt and processing of user inputs associated with a virtual STB.

With reference to FIG. 1, the customer device 110 may include one or more processors 171, one or more memory devices 172, one or more input/output (“I/O”) interfaces 173, and/or one or more network interfaces 174. The processors 171 may be configured to execute any number of software applications and/or computer-readable or computer-executable instructions. The memory devices 172 may include any number of suitable memory devices, such as caches, read-only memory devices, random access memory devices, flash memory devices, magnetic storage devices, removable storage devices (e.g., memory cards, etc.), and/or other memory devices. The memory devices 172 may include internal memory devices and/or external memory devices in communication with the customer device 110. The memory devices 172 may store data, executable instructions, and/or various program modules utilized by the processors 171. Examples of data that may be stored by the memory devices 172 include data files 175 and/or any number of suitable program modules that may be executed by the processors 171, such as an operating system (“OS”) 176, a browser application 177, and/or a dedicated virtual STB application 178.

The data files 175 may include any suitable data that facilitates the operation of the customer device 110, the establishment of a communications session with a service provider computer 105, the receipt of virtual STB information, and/or the processing of received user input. For example, the data files 175 may include, but are not limited to, customer profile information (e.g., customer preferences associated with a virtual STB, desired resolution, desired content protection, etc.), device profile information (e.g., customer device identification information, customer device capabilities, etc.), information that facilitates communication with the service provider computers 105, received content, and/or customer input received in association with a virtual STB.

The OS 176 may be a suitable software module that controls the general operation of the customer device 110. The OS 176 may also facilitate the execution of other software modules, for example, the browser application 177 and/or the dedicated virtual STB application 178. In certain embodiments, a suitable browser application 177, such as a Web browser, may be utilized to establish communication with a service provider computer 105. For example, a browser application 177 may be utilized to access a Web portal that facilitates the initiation of a virtual STB. In other embodiments, a dedicated virtual STB application 178 (e.g., an application provided by the service provider, an application received from an application store, etc.) may be utilized to establish communication with a service provider computer 105 or a suitable portal in order to initiate a virtual STB.

Regardless of whether a browser application 177 or a dedicated virtual STB application 178 is utilized, in operation, the application may be utilized to access a suitable portal provided by the service provider, such as a Web portal hosted by a service provider computer 105. Access and/or authentication credentials for a customer and/or the customer device 110 may then be provided along with a request to initiate a virtual STB. In certain embodiments, a wide variety of other information may also be provided to a service provider computer 105 in association with a request to initiate a virtual STB, such as information associated with customer device capabilities, customer profile information, and/or customer preference and/or parameters. At least a portion of the information may be utilized by a virtual STB module 158 associated with the service provider computer 105 during the initiation of a virtual STB.

Once a virtual STB has been initiated, one or more interfaces may be generated by the virtual STB modules 158 and communicated to the customer device 110. The one or more interfaces may facilitate the presentation of virtual STB information (e.g., content, program guide information, etc.) via the customer device 110. Additionally, the one or more interfaces may facilitate the receipt of customer input associated with a virtual STB. A few example interfaces are described in greater detail below with reference to FIG. 5.

With continued reference to the customer device 110, the one or more I/O interfaces 173 may facilitate communication between the customer device 110 and one or more input/output devices, for example, one or more user interface devices, such as a display, keypad, mouse, pointing device, control panel, touch screen display, microphone, speaker, etc., that facilitate user interaction with the customer device 110. In this regard, user commands may be received by the customer device 110, and received content may be output. The one or more network interfaces 174 may facilitate connection of the customer device 110 to one or more suitable networks, such as networks 115. In this regard, the customer device 110 may communicate with any number of the other components of the system 100.

As desired in certain embodiments, one or more content providers may be provided. A content provider may include any number of suitable devices and/or systems configured to provide broadband content and/or additional content to the service provider for delivery to a customer device 110 via a virtual STB. An example content provider may be a content provider associated with a television network. As desired, a content provider may include any number of systems and/or devices having components similar to those described above for the service provider computer 105, such as one or more processors, memory devices, I/O interfaces, and/or network interfaces.

Communications between various components of the system 100 may be facilitated via any number of suitable networks, such as the illustrated networks 115. As desired, these networks 115 may include any number of public and/or private networks. Example networks include, but are not limited to, cable networks, satellite networks, telecommunication networks, data networks, wide area networks, the Internet, public switched telephone networks, satellite networks, and/or any combination thereof and may be wired and/or wireless. In certain embodiments, the networks 115 may include one or more private networks and/or backbone networks associated with a service provider (e.g., a cable service provider, etc.). Additionally, as desired, any number of suitable devices such as gateways and/or routers, may be provided to facilitate connectivity between or among networks.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionalities described with respect to the system components shown in FIG. 1.

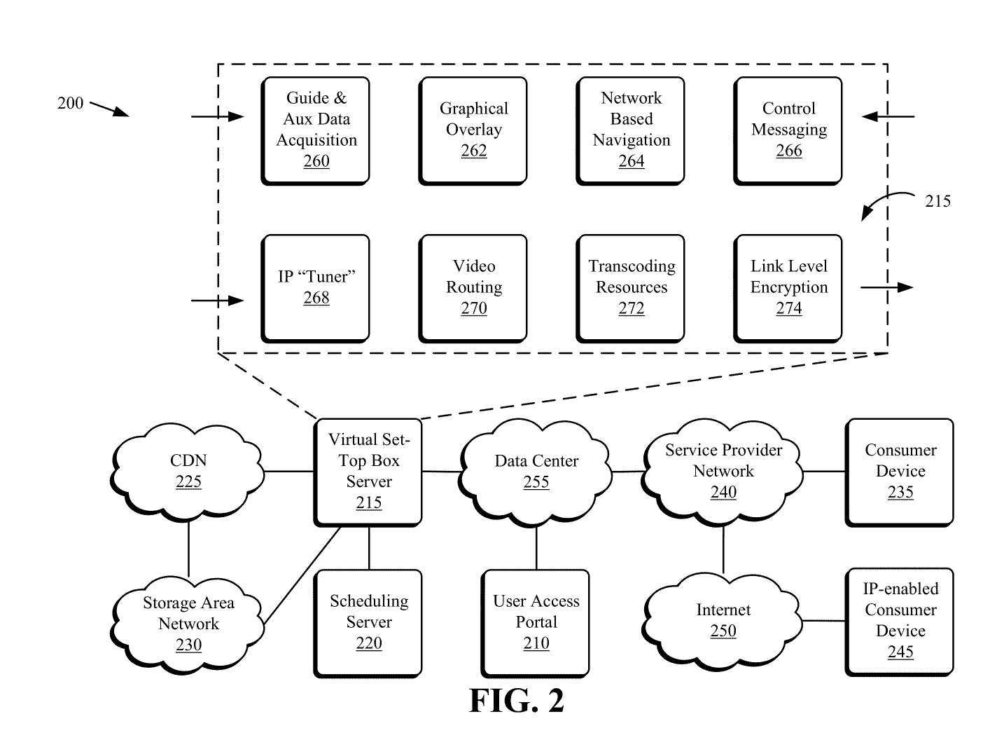

As desired in various embodiments, a wide variety of different architectures may be utilized to form a service provider system that provides virtual STBs. For example, a wide variety of different architectures of service provider computers may be utilized as desired. FIG. 2 is a block diagram of one example architecture 200 of a virtual STB service provider system that may be utilized. Each component of the architecture 200 may include any number of suitable hardware and/or software components that facilitate the provision of virtual STBs. With reference to FIG. 2, at a service provider or network level, the architecture 200 may include a user access portal 210, a virtual STB server 215, a scheduling server 220, one or more content delivery networks 225, and a storage area network 230.

The user access portal 210 may facilitate the establishment of communications sessions with any number of suitable consumer devices. For example, a first consumer device 235 may connect to the user access portal 210 via a suitable service provider network 240, such as a cable network. As another example, an IP-enabled consumer device 245 may connect to the user access portal 210 via a combination of the Internet 250 and the service provider network 240. Indeed, a wide variety of different types of consumer devices may access the user access portal 210 via any number of suitable networks and/or interfaces.

The user access portal 210 may enable log in and/or authentication procedures for the consumer devices 235, 245 and/or associated consumers. In this regard, the user access portal 210 may validate subscription levels for the consumers and/or consumer devices 235, 245. For example, the user access portal 210 may determine whether a virtual STB has been previously established (e.g., purchased, rented, etc.) by the consumer and/or in association with a consumer account. Additionally, in certain embodiments, the user access portal 210 may facilitate the establishment (e.g., purchase, rental, etc.) of a new virtual STB. Once a consumer or a consumer device 235 245 has been authenticated, the user access portal 210 may assign virtual STB resources on behalf of a consumer or a consumer device 235, 245. For example, the user access portal 210 may direct the initiation of a virtual STB on a virtual STB server 215 on behalf of a consumer or a consumer device 235, 245. The user access portal 210 may then redirect the consumer or the consumer device 235, 245 to the virtual STB server 215 on which a virtual STB has been initiated.

In certain embodiments, a data center 255 may also be included in the architecture 200, and the data center 255 may form an interface between one or more service provider components and any number of consumer devices 235, 245. For example, the data center 255 may form a suitable Web server or other interface that may be utilized to connect a consumer device to the user access portal 210 or the virtual STB server 215.

The virtual STB server 215 may host virtual STBs on behalf of any number of consumers and/or consumer devices 235, 245. The virtual STB server 215 may interface with the content delivery networks (“CDNs”) 225 and/or the storage area network 230. In doing so, the virtual STB server 215 may receive, access, and/or otherwise obtain content that may be delivered to consumer devices 235, 245 via virtual STBs. A content delivery network 225 may include any number of suitable networks and/or network components that facilitate the receipt of content from any number of content providers and/or the storage of content (e.g., received content, generated content, etc.). The storage area network 230 may include any number of suitable components and/or network connections that facilitate the storage of content on behalf of consumers and the delivery of stored content to the virtual STB server 215. In certain embodiments, unique copies of content (or unique copies of various portions of the content) may be stored on the storage area network 230 on behalf of one or more respective consumers (or consumer accounts). As desired, content may be stored at the request of one or more consumers. The scheduling server 220 may include any number of suitable components that schedule and/or direct the storage of content (e.g., live streaming content, etc.) in the storage area network 230. For example, the scheduling server 220 may receive consumer content recording requests from the virtual STB server 215, and the scheduling server 220 may direct the storage of content in response to received consumer requests.

With continued reference to the virtual STB server 215, the virtual STB server 215 may also perform any number of functions that are traditionally performed by a physical STB. For example, the virtual STB server 215 and/or an initiated virtual STB may facilitate the execution of navigation and/or interactive services applications (e.g., an interactive program guide application, an EBIF application, a pay-per-view application, on-demand application, etc.), and/or the acquisition and/or processing of data associated with these applications. Additionally, in certain embodiments, the virtual STB server 215 and/or an initiated virtual STB may facilitate interaction with the scheduling server 220 (e.g., interaction with a network recording server, etc.), content acquisition services (e.g., content streaming, real-time and/or non-real-time content delivery, the delivery of stored and/or recorded content, etc.), content decoding (full decoding, partial decoding, etc.), graphic rendering and/or overlay functions, adaptive content transcoding and/or segmenting/fragmenting, and/or a wide variety of content protection functions.

As desired in various embodiments, the virtual STB server 215 may include any number of modules, sub-modules, and/or components. For example, with reference to FIG. 2, the virtual STB server 215 may include a guide and auxiliary data acquisition module 260, a graphical overlay module 262, a network-based navigation module 264, a control messaging module 266, an IP “tuner” module 268, a video routing module 270, any number of transcoding resources 272, and/or a link level encryption module 274. These components may facilitate the performance of a wide variety of different types of virtual STB functions. In one example embodiment, the guide and auxiliary data acquisition module 260 may collect, generate, and/or obtain electronic program guide (“EPG”) data and/or other auxiliary data that may be delivered to a consumer device 235, 245 via a virtual STB. The graphical overlay module 262 may facilitate the overlay of EPG data and/or other data into a video stream and/or presentation for delivery to a consumer device 235, 245. Additionally, the graphical overlay module 262 may facilitate the generation and/or customization of any number of suitable interfaces associated with a virtual STB. The network-based navigation module 264 may facilitate the selection and delivery of a wide variety of different types of network content, such as Internet content, stored content, etc. The control messaging module 266 may facilitate the receipt of user/consumer commands associated with a virtual STB, as well as the communication of control messages and/or input requests to consumer devices 235, 245. The IP “tuner” module 268 may facilitate the tuning of a virtual STB to various content, such as IP television content delivered via the virtual STB. The video routing module 270 may facilitate the processing and delivery of video content to a consumer device 235, 245, as well as the formatting of content. The transcoding resources 272 and the link level encryption module 274 (as well as other coding and/or data protection modules) may facilitate the encoding and/or encrypting of content delivered to the consumer device 235, 245. In this regard, protection and/or security may be provided for delivered content.

The architecture 200 shown in and described with respect to FIG. 2 is provided by way of example only. Numerous other architectures are possible, which may include fewer or greater numbers of components and may incorporate some or all of the functionalities described with respect to the various components shown in FIG. 2.

Operational Overview

FIGS. 3-5 are flow diagrams showing respective processes 300, 400, and 500 for providing virtual STB functionality. These processes are illustrated as logical flow diagrams, each operation of which represents a sequence of operations that can be implemented in hardware, software, or a combination thereof. In the context of software, the operations may represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

FIG. 3 is a flow diagram of an example method 300 for utilizing a virtual STB to deliver content to a customer device. In accordance with the method 300, one or more service provider computers, such as the service provider computers 105 illustrated in FIG. 1, may host a virtual STB on behalf of a customer, and the virtual STB may facilitate the delivery of content to a customer device, such as one of the customer devices 110A-N illustrated in FIG. 1. As such, in certain embodiments, the operations of the method 300 may be performed by any number of suitable service provider computers 105 and/or associated virtual STB modules, such as the virtual STB modules 158 illustrated in FIG. 1. The method 300 may begin at block 305.

At block 305, a virtual STB may be established by association with either a customer or a customer account. For example, a customer may register for and, in certain embodiments, be charged for a virtual STB. In certain embodiments, the customer may “rent” resources, such as cloud resources or network-based resources, that are utilized to provide virtual STB functionality to one or more customer devices 110A-N associated with the customer or customer account. During the establishment of a virtual STB, a wide variety of suitable information associated with the virtual STB may be generated and/or received. At least a portion of the information may be stored at block 310. Examples of information associated with the establishment of a virtual STB include, but are not limited to, identifiers of one or more customers, an identifier of a customer account, customer and/or customer account profile information, identifiers of one or more customer devices, parameters associated with the capabilities of the one or more customer devices (e.g., network transmission capabilities, display capabilities, other output capabilities, input capabilities, etc.), preferences associated with the delivery of content (e.g., streaming preferences, resolution preferences, transcoding preferences, content protection preferences, etc.), and/or preferences associated with the storage of content by one or more network service provider computers 105.

Once established, a virtual STB may be accessed by a customer utilizing any number of suitable customer devices 110A-N, such as a personal computer, a tablet computer, a mobile device, a network-enabled television, etc. In this regard, the virtual STB may provide content to the customer device. Additionally, the virtual STB may facilitate the protection and security of delivered content. At block 315, a communications session may be established with a customer device 110. For example, a customer device 110 may connect and/or log into a virtual STB service or virtual STB portal hosted by the service provider computers 105. Once the customer device 110 and/or a customer (or customer account) associated with the customer device 110 has been authenticated and/or verified (e.g., authenticating log-in information, verifying subscription levels, etc.), an instance of a virtual STB may be initiated or instantiated at block 320 on behalf of the customer. In other words, a virtual STB application may be initiated on a service provider computer 105 on behalf of a customer.

The virtual STB may provide functionality similar to that provided by a conventional STB, such as a conventional STB connected to a television. Examples of suitable services that may be provided by a virtual STB include, but are not limited to, the delivery of television content, electronic program guide (“EPG”) functionality, enhanced television binary interchange format (“EBIF”) functionality, Internet television functionality, video on-demand functionality, pay-per-view functionality, network recording functionality, voice over Internet protocol (“VoIP”) functionality, caller identification functionality, and/or parental control functionality. In certain embodiments, a virtual STB may provide content navigation and/or interactive services that produce any number of graphical outputs that are overlaid on a video output communicated to a customer device 110.

At block 325, one or more parameters for communicating virtual STB content to the customer device 110 may be identified. A wide variety of suitable parameters may be identified as desired in various embodiments, such as network resources (e.g., available bandwidth, latency, available memory, etc.), capabilities of a customer device (e.g., display capabilities, input capabilities, etc.), and/or user preferences (e.g., desired resolution, dynamic resolution preferences, frame rate preferences, etc.). As desired in various embodiments, the identified parameters may include stored parameters that are accessed from memory and/or parameters received from the customer device 110.

At block 330, content to be communicated to the customer device 110 in association with the virtual STB may be identified or determined. The content may then be formatted in accordance with at least a portion of the parameters. For example, content may be tailored for presentation via the customer device 110 based upon one or more parameters associated with the customer device 110, one or more user preferences (e.g., desired resolution, etc.), and/or available network resources. Once formatted, the content may be communicated to the customer device 110 at block 335. One example of the operations for formatting and communicating content to the customer device 110 is described in greater detail below with reference to FIG. 4. A wide variety of suitable content may be communicated to the customer device 110 as desired in various embodiments of the invention. Examples of suitable content include video content, audio content, Internet content, stored or recorded content, and/or a wide variety of data associated with display and/or input interfaces.

In certain embodiments, the virtual STB may generate any number of suitable interfaces that facilitate the delivery of content to the customer device 110. As desired, a generated interface may facilitate the receipt of customer input. For example, a generated interface may facilitate the receipt of customer inputs similar to inputs received by a conventional STB, such as tuning inputs, content selection inputs, purchase inputs, recording inputs, and/or requests to view content recorded at a network level. In certain embodiments, a generated interface may be tailored to the input capabilities of the customer device 110. For example, if the customer device 110 has a touch screen display, then an interface may facilitate the receipt of touch screen input that is communicated to the virtual STB for processing. One example of the operations that may be utilized to generate an interface is described in greater detail below with reference to FIG. 5.

Although the method 300 is illustrated as ending after block 335, in certain embodiments, content may be delivered to the customer device 110 until a virtual STB is closed or until communication with the customer device 110 is lost. As desired, the content may be adjusted and/or formatted in response to received user inputs and/or requests.

FIG. 4 is a flow diagram of an example method 400 for determining a resolution for communicating content to a customer device via a virtual STB. In certain embodiments, the operations of the method 400 may be performed by any number of suitable service provider computers and/or associated virtual STB modules, such as the service provider computers 105 and/or virtual STB modules 158 illustrated in FIG. 1. The method 400 may begin at block 405.

At block 405, one or more resolution parameters and/or other parameters (e.g., frame rate parameters, etc.) associated with the delivery of content via a virtual STB may be identified. The parameters may be identified from a wide variety of different sources as desired in various embodiments of the invention. For example, stored parameters, such as parameters stored during the establishment of a virtual STB or parameters subsequently stored in association with the virtual STB (e.g., parameters received via a Website, a previous virtual STB session, etc.), may be accessed from memory and/or any number of remote data sources at block 410. As another example, one or more parameters may be received from a customer device 110 and identified at block 415.

At block 420, a determination may be made as to whether content should be delivered to a customer device 110 at a dynamically determined and/or adapted resolution. For example, a determination may be made as to whether one or more customer parameters indicate that the customer desires to received content at a dynamic resolution. In certain embodiments, a dynamic resolution may be determined based upon available network resources. Additionally, in certain embodiments, a customer may specify that a dynamic resolution will be adapted within a specified range of resolution values. For example, the customer may specify that resolution may be dynamically determined between approximately 720p resolution and/or approximately 1080p resolution.

If it is determined at block 420 that the resolution is not dynamically determined, then operations may continue at block 425. At block 425, a fixed resolution for delivering content to the customer device 110 may be identified. For example, a fixed resolution specified by the customer (e.g., stored in a customer profile, received from the customer device 110, etc.) may be identified. At block 430, a determination may be made as to whether network resources are available for communicating content to the customer device 110 at the identified fixed resolution. For example, a determination may be made as to whether sufficient bandwidth is available for streaming or otherwise communicating content at the identified fixed resolution. Additionally, in certain embodiments, a determination may be made as to whether the customer device 110 is capable of receiving and outputting content at the desired fixed resolution. If it is determined at block 430 that sufficient resources are not available for delivering the content at the identified fixed resolution, then operations may continue at block 435, and a suitable error message may be generated and delivered to the customer device 110 for output to the customer. For example, an error message stating that sufficient resources are not available for delivering content at the fixed resolution may be generated and delivered. In certain embodiments, the customer may be invited to adjust a fixed resolution or to utilize dynamic resolution in order to deliver content. Operations may either end following block 435 or, if the customer adjusts a desired resolution, additional processing may be performed.

If, however, it is determined at block 430 that sufficient resources are available for delivering content at the fixed resolution, then operations may continue at block 440. At block 440, content may be formatted for output to the customer device 110. For example, content may be formatted in accordance with the fixed resolution and/or in accordance with output capabilities of the customer device 110. The content may then be encrypted or otherwise processed (e.g., transcoded, segmented, fragmented, containerized, etc.) at block 445 in order to provide protection and/or security for the content. The encrypted or protected content may then be output for communication to the customer device 110 at block 450. As shown in FIG. 4, operations of the method 400 may end following the delivery of content at block 450. In other embodiments, the delivery of content may be adjusted based at least in part upon received user input until a virtual STB is closed.

With continued reference to FIG. 4, if it is determined at block 420 that the resolution may be dynamically determined then operations may continue at block 455. At block 455, one or more available resolutions and/or available ranges of resolutions may be identified for delivering content. For example, a customer's subscription level(s) may be reviewed in order to determine available resolutions (e.g., standard resolution, high-definition resolution, etc.) for delivering selected content (e.g., television content, on-demand content, pay-per-view content, etc.).

At block 460, display and/or output capabilities of the customer device 110 may be identified. For example, the customer device 110 may be identified at block 465. A wide variety of suitable techniques may be utilized as desired to identify the customer device 110. For example, a device identifier (e.g., a media access control address, etc.) may be evaluated (e.g., compared to stored device information associated with the virtual STB) in order to identify the customer device 110. As another example, device identification information may be received from the customer device 110. At block 470, display capabilities associated with the identified customer device 110 may be determined. For example, parameters associated with resolutions that may be displayed by the customer device 110 (e.g., high definition capabilities, etc.) may be determined. In certain embodiments, customer device capabilities may be determined based at least in part upon an evaluation of stored information associated with a virtual STB. In other embodiments, customer device capability information may be received from the customer device 110 and evaluated in order to determine display capabilities of the customer device 110.

At block 475, available network resources may be determined. For example, available network bandwidth, processing resources, and/or memory resources may be determined. At block 480, a resolution for communicating content to the customer device 110 may be determined based at least in part upon the available network resources and, in certain embodiments, the customer device capabilities. As one example, network resources may be evaluated in order to determine a range of resolutions (or a maximum resolution) at which content may be delivered. The available range of resolutions may then be compared to customer preferences (e.g., a desired resolution, a desired range of resolutions, etc.) and/or device capabilities in order to determine a resolution for communicating content. In the event that content cannot be delivered within a desired resolution range, then an error message may be delivered in a similar manner as that described above with reference to block 435.

Otherwise, the determined resolution may be utilized at block 485 to format content for output to the customer device 110. The content may then be encrypted and/or otherwise processed (e.g., transcoded, segmented, fragmented, containerized, etc) at block 490 in order to provide protection and/or security for the content. The encrypted or protected content may then be output for communication to the customer device 110 at block 495. As shown in FIG. 4, operations of the method 400 may end following the delivery of content at block 495. In other embodiments, the delivery of content may be adjusted based at least in part upon received user input until a virtual STB is closed.

FIG. 5 is a flow diagram of an example method for generating one or more interfaces associated with a virtual STB. In certain embodiments, the operations of the method 500 may be performed by any number of suitable service provider computers and/or associated virtual STB modules, such as the service provider computers 105 and/or virtual STB modules 158 illustrated in FIG. 1. The method 500 may begin at block 505.

At block 505, a customer device 110 utilized by a customer to access a virtual STB may be identified. A wide variety of suitable techniques may be utilized as desired to identify the customer device 110. For example, a device identifier (e.g., a media access control address, etc.) may be evaluated (e.g., compared to stored device information associated with the virtual STB) in order to identify the customer device 110. As another example, device identification information may be received from the customer device 110. At block 510, input/output capabilities associated with the identified customer device 110 may be determined. For example, parameters associated with available input/output devices (e.g., touch screen displays, other displays, a keyboard, a mouse, a remote control, a keypad, etc.) may be identified or determined. In certain embodiments, customer device input/output capabilities may be determined based at least in part upon an evaluation of stored information associated with a virtual STB. In other embodiments, customer device input/output capability information may be received from the customer device 110 and evaluated in order to determine the capabilities of the customer device 110.

At block 515, one or more preferences for generating an interface to be utilized in association with the customer device 110 may be identified. For example, one or more user preferences stored in association with the virtual STB may be accessed and evaluated in order to determine desired formatting associated with interfaces. As another example, one or more service provider preferences for formatting interfaces may be evaluated in order to determine desired formatting. At block 520, at least one interface associated with the virtual STB may be generated. A wide variety of different interfaces may be generated as desired in various embodiments. In certain embodiments, device capabilities and/or identified preferences may be utilized to generate the interface. For example, user preferences may specify desired formatting to be utilized in association with an electronic program guide interface (or any other suitable interface). Device capabilities may then indicate that a customer device 110 is capable of receiving input via a touch screen display. Accordingly, an electronic program guide interface may be generated that is formatted in accordance with the user preferences and that is further formatted in order to receipt touch screen input. Other example interfaces will be appreciated.

At block 525, the generated at least one interface may be communicated to the customer device 110. In certain embodiments, the at least one interface may be communicated in order to facilitate the delivery of other content in association with a virtual STB, such as television content and/or stored content. Additionally, as desired in certain embodiments, the at least one interface may be configured to facilitate the receipt of a wide variety of user input. For example, a user interface output by a customer device 110 may receive customer STB input, and the received STB input may be communicated to a service provider computer 105 hosting the virtual STB. The STB input may then be received by the service provider computer 105 at block 530. At block 535, the received STB input may be processed and/or evaluated. A wide variety of different actions may be taken as desired based upon processing the received STB input. For example, the content that is delivered to the customer device 110 may be adjusted or modified (e.g., television content may be tuned to another channel, stored content may be delivered, EPG data may be delivered, etc.).

As shown in FIG. 5, operations of the method 500 may end following the processing of the received input at block 535. In other embodiments, the delivery of content may be adjusted based at least in part upon received user input until a virtual STB is closed.

The operations described and shown in the methods 300, 400, and 500 of FIGS. 3-5 may be carried out or performed in any suitable order as desired in various embodiments of the disclosure. Additionally, in certain embodiments, at least a portion of the operations may be carried out in parallel. Furthermore, in certain embodiments, less than or more than the operations described in FIGS. 3-5 may be performed.

As a result of utilizing virtual STB, customers of a service provider (e.g., a cable service provider, etc.) may be permitted to receive content via a wide variety of different devices and, in certain embodiments, at a wide variety of different locations (e.g., within a customer's home, outside the home, etc.). Additionally, with virtual STBs, there is no need to situate service provider equipment (e.g., a cable STB, a DVR, etc.) at a customer location. Accordingly, a service provider will incur relatively lower maintenance costs, and the number of service calls (e.g., in-home service calls, etc.) will likely be reduced. Additionally, the use of network servers to host virtual STB functionality may provide a scalable system that is relatively easy to upgrade in order to provide additional functionality.

Various block and/or flow diagrams of systems, methods, apparatus, and/or computer program products according to example embodiments of the disclosure are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

Many modifications and other embodiments of the disclosure set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method, comprising:
establishing, by a service provider system comprising one or more computers, a virtual set-top box associated with at least one of a customer of a service provider or a customer account with the service provider;
establishing, by the service provider system via a wide area network, a communications session with a customer device;
initiating, by the service provider system based upon the established communications session, the virtual set-top box;
identifying, by the service provider system, one or more parameters associated with the communications session for communicating content from the virtual set-top box to the customer device; and
communicating, by the service provider system to the customer device based at least in part upon the identified one or more parameters, the content.

2. The method of claim 1, wherein identifying one or more parameters comprises identifying at least one of (i) a bandwidth for communicating the content, (ii) a resolution for communicating the content, or (iii) a type of content protection to utilize in association with the content.

3. The method of claim 1, wherein identifying one or more parameters comprises:
receiving, by the service provider system from the customer device, at least one of the one or more parameters; and
identifying the at least one received parameter.

4. The method of claim 1, wherein identifying one or more parameters comprises identifying one or more parameters associated with the dynamic determination of a resolution for communicating the content.

5. The method of claim 4, wherein the one or more parameters comprise at least one of (i) one or more available resolutions for the content, (ii) one or more display capability parameters for the customer device, or (iii) one or more parameters associated with available resources for the wide area network.

6. The method of claim 1, further comprising:
generating, by the service provider system in association with the virtual set-top box, at least one interface configured to receive input from the customer device; and
communicating, by the service provider system, information associated with the at least one interface to the customer device.

7. The method of claim 6, wherein generating at least one interface comprises:
identifying one or more input/output parameters associated with the customer device; and
generating the at least one interface based at least in part upon the one or more input/output parameters.

8. The method of claim 1, wherein the virtual set-top box is configured to provide at least one of (i) electronic program guide functionality, (ii) enhanced television binary interchange format functionality, (iii) caller identification functionality, (iv) Internet television functionality, (v) live streaming functionality, (vi) recording functionality, (vii) video on-demand functionality, (viii) pay-per-view functionality, or (ix) parental control functionality.

9. The method of claim 1, wherein initiating the virtual set-top box comprises initiating the virtual set-top box on a cloud computing server.

10. The method of claim 1, further comprising:
receiving, by the service provider system from the customer device, authentication information associated with the customer of a service provider or the customer account with the service provider,
wherein initiating the virtual set-top box comprises initiating the virtual set-top box based at least in part upon a validation of the received authentication information.

11. The method of claim 1, further comprising:
receiving, by the service provider computer from the customer device via the virtual set-top box, a request to record desired content; and
scheduling, by the service provider computer based at least in part upon the received request, a recording of the desired content.

12. A system, comprising:
at least one memory operable to store computer-executable instructions; and
at least one processor configured to access the at least one memory and execute the computer-executable instructions to:
establish a virtual set-top box associated with at least one of a customer of a service provider or a customer account with the service provider;
establish, via a wide area network, a communications session with a customer device;
initiate, based upon the established communications session, the virtual set-top box;
identify one or more parameters associated with the communications session for communicating content from the virtual set-top box to the customer device; and
communicate, to the customer device based at least in part upon the identified one or more parameters, the content.

13. The system of claim 12, wherein the one or more parameters comprise at least one of (i) a bandwidth for communicating the content, (ii) a resolution for communicating the content, or (iii) a type of content protection to utilize in association with the content.

14. The system of claim 12, wherein the at least one processor is configured to identify the one or more parameters by executing the computer-executable instructions to:
receive, from the customer device, at least one of the one or more parameters; and
identify the at least one received parameter.

15. The system of claim 12, wherein the one or more parameters comprise one or more parameters associated with the dynamic determination of a resolution for communicating the content.

16. The system of claim 15, wherein the one or more parameters comprise at least one of (i) one or more available resolutions for the content, (ii) one or more display capability parameters for the customer device, or (iii) one or more parameters associated with available resources for the wide area network.

17. The system of claim 12, wherein the at least one processor is further configured to execute the computer-executable instructions to:
generate, in association with the virtual set-top box, at least one interface configured to receive input from the customer device; and
direct communication of information associated with the at least one interface to the customer device.

18. The system of claim 17, wherein the at least one processor is configured to generate the at least one interface by executing the computer-executable instructions to:
identify one or more input/output parameters associated with the customer device; and
generate the at least one interface based at least in part upon the one or more input/output parameters.

19. The system of claim 12, wherein the virtual set-top box is configured to provide at least one of (i) electronic program guide functionality, (ii) enhanced television binary interchange format functionality, (iii) caller identification functionality, (iv) Internet television functionality, (v) live streaming functionality, (vi) recording functionality, (vii) video on-demand functionality, (viii) pay-per-view functionality, or (ix) parental control functionality.

20. The system of claim 12, wherein the virtual set-top box is initiated on a cloud computing server.

21. The system of claim 12, wherein the at least one processor is further configured to execute the computer-executable instructions to:
receive, from the customer device, authentication information associated with the customer of a service provider or the customer account with the service provider; and
initiate the virtual set-top box based at least in part upon a validation of the received authentication information.

22. The system of claim 12, wherein the at least one processor is further configured to execute the computer-executable instructions to:
receive, from the customer device via the virtual set-top box, a request to record desired content; and
schedule, based at least in part upon the received request, a recording of the desired content.
